(19) United States
(12) Patent Application Publication
(10) Pub. No.: US 2025/0273056 A1
(43) Pub. Date: Aug. 28, 2025

(54) PORTABLE PAYMENT TERMINAL

(71) Applicant: Panasonic Intellectual Property Management Co., Ltd., Osaka (JP)

(72) Inventors: Shinya AOYAMA, Tokyo (JP); Tadayuki TAKANASHI, Kanagawa (JP); Takahiro NARUSE, Kanagawa (JP)

(73) Assignee: Panasonic Intellectual Property Management Co., Ltd., Osaka (JP)

(21) Appl. No.: 18/985,590

(22) Filed: Dec. 18, 2024

(30) Foreign Application Priority Data
Feb. 28, 2024 (JP) 2024-028560
Apr. 17, 2024 (JP) 2024-066883

(51) Int. Cl. G07G 1/00; G06Q 20/34

(52) U.S. Cl. CPC G07G 1/0018; G06Q 20/352; G06Q 20/353

(57) ABSTRACT

A portable payment terminal includes: a touch panel including a display on a front of a housing; a slot into which a contact IC card is to be inserted; a slit through which a magnetic card is to be swiped; a lens being arranged on the front; and a speaker unit. The slot is arranged on a top of the housing and is within a width of the display, the slit is arranged across the top of the housing and two housing sides adjacent to the top, the slot and the slit are arranged substantially parallel to the front, an insertion direction of the contact IC card and a swipe direction of the magnetic card are arranged substantially perpendicular to each other, and the lens and the speaker unit are arranged closer to a bottom of the housing with respect to the display and within the width of the display.

### BACKGROUND

### 1. Technical Field

The present disclosure relates to a portable payment terminal.

### 2. Description of the Related Art

As the payment terminal, for example, a device that is installed at a counter of a shop and performs payment is known. The payment terminal includes a touch panel, and can perform payment on the basis of personal information input from the touch panel. In addition, the payment terminal is also compatible with a payment medium such as a card, and can perform payment by reading personal information or the like from such a medium.

With the diversification of transactions in recent years, the place of payment is not limited to a store counter, but has been expanded to various places. For example, this is a case where payment for a home delivery article is made at a delivery destination. For this reason, a portable payment terminal that can be carried is more emphasized (see Patent Literatures (PTLs) 1 to 3).
PTL 1: Unexamined Japanese Patent Publication No. 2019-144944 A
PTL 2: Unexamined Japanese Patent Publication No. 2012-185543 A
PTL 3: Unexamined Japanese Patent Publication No. 2017-228237 A

### SUMMARY

The portable payment terminal is required to be downsized for carrying. However, there are various types of payment such as code payment, contactless payment, payment by a contact IC card, and payment by a magnetic card, and the device used differs depending on the type of payment. When the terminal is equipped with a plurality of different devices, downsizing is more difficult. In particular, a component (hereinafter, referred to as a tall component) having a tall portion (long in the thickness direction of the terminal) such as a camera, a speaker, or the like increases the thickness of the terminal, and can be an obstacle to miniaturization.

The present disclosure provides a portable payment terminal capable of making payment by various payment methods and achieving downsizing, particularly thinning.

A portable payment terminal of the present disclosure includes: a touch panel including a display, the touch panel being on a front of a housing; an antenna used for contactless payment; a slot into which a contact IC card for payment processing is to be inserted; a slit through which a magnetic card for the payment processing is to be swiped; a lens of a first camera that images a code of the payment processing, the lens being arranged on the front; and a speaker unit that is in the housing and outputs a sound of the payment processing. The slot is arranged on a top of the housing and is within a width of the display, the slit is arranged across the top of the housing and two housing sides adjacent to the top, the slot and the slit are arranged substantially parallel to the front of the housing, an insertion direction of the contact IC card into the slot and a swipe direction of the magnetic card into the slit are arranged substantially perpendicular to each other, and the lens and the speaker unit are arranged closer to a bottom of the housing with respect to the display and within the width of the display.

According to the present disclosure, payment can be made by various payment methods, and downsizing, particularly thinning, of a portable payment terminal can be achieved.

### BRIEF DESCRIPTION OF THE DRAWINGS

FIG. 1 is a front view illustrating a configuration example of a portable payment terminal according to an exemplary embodiment of the present disclosure;

FIG. 2 is a rear view illustrating a configuration example of the portable payment terminal;

FIG. 3 is a top view illustrating a configuration example of the portable payment terminal;

FIG. 4 is a bottom view illustrating a configuration example of the portable payment terminal;

FIG. 5 is a left side view illustrating a configuration example of the portable payment terminal;

FIG. 6 is a right side view illustrating a configuration example of the portable payment terminal;

FIG. 7 is a cross-sectional view taken along line I-I in FIG. 1;

FIG. 8 is a cross-sectional view taken along line II-II in FIG. 1;

FIG. 9 is a cross-sectional view taken along line III-III in FIG. 1;

FIG. 10 is a first perspective view illustrating a schematic configuration example of the portable payment terminal; and

FIG. 11 is a second perspective view illustrating a schematic configuration example of the portable payment terminal.

### DETAILED DESCRIPTIONS

Exemplary embodiments will now be described below in detail, referring to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art. Note that the accompanying drawings and the following description are provided for those skilled in the art to fully understand the present disclosure, and are not intended to limit the subject matter described in the claims.

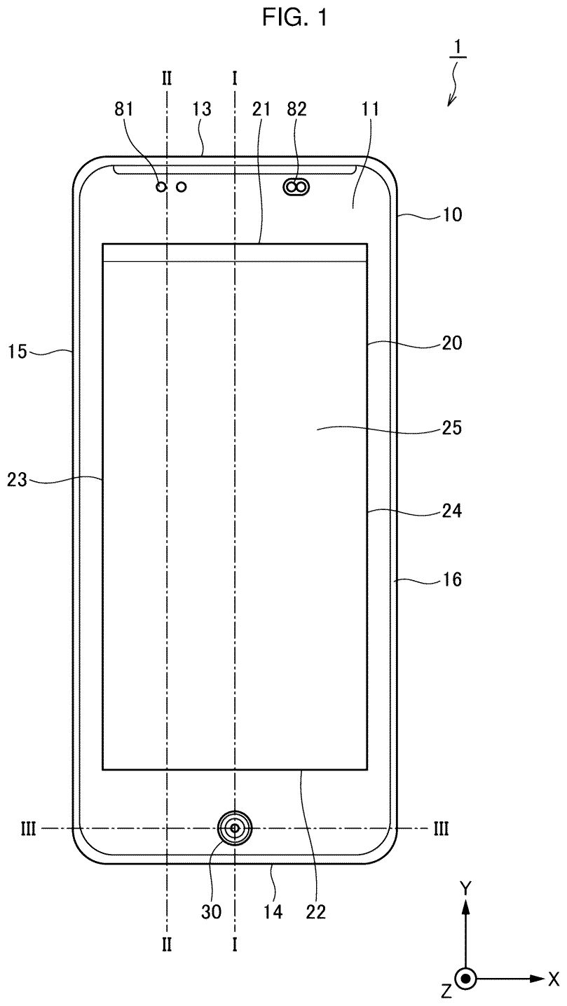

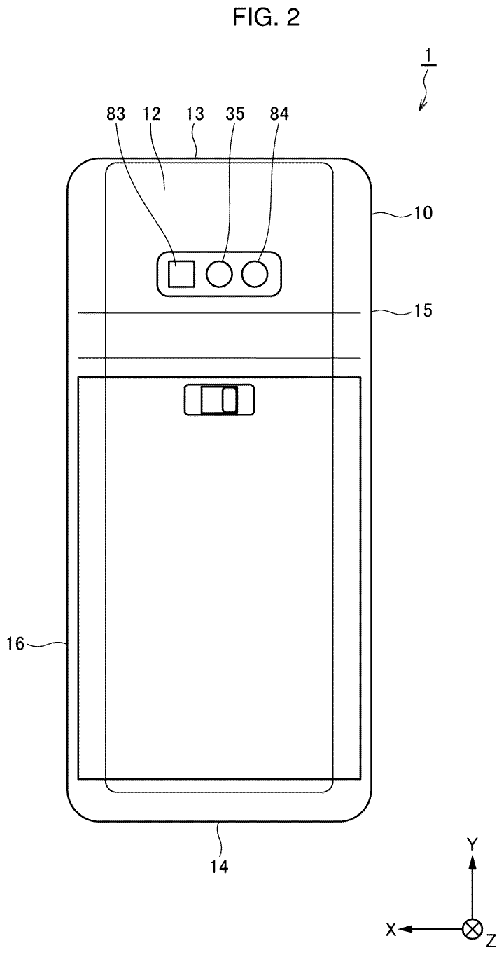

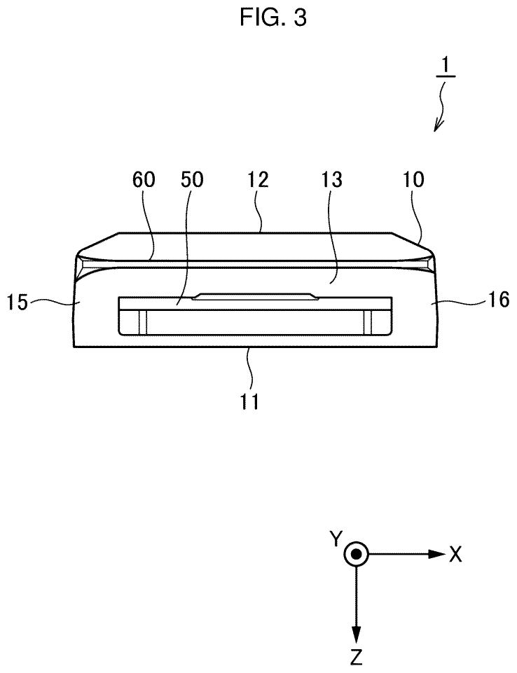

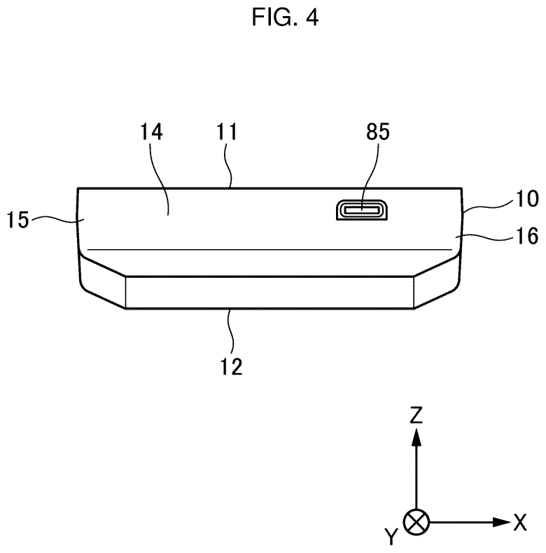

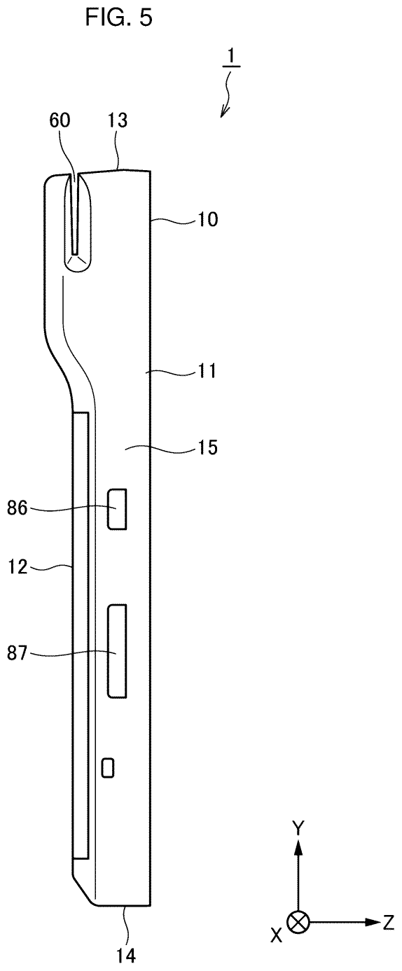

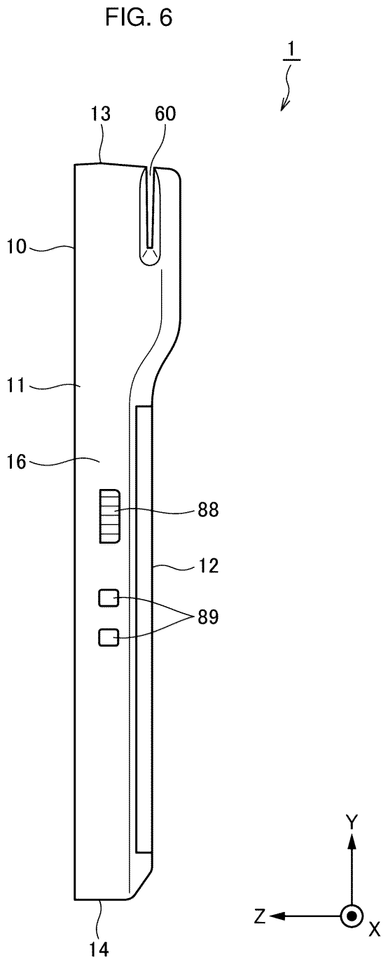

FIG. 1 is a front view illustrating a configuration example of portable payment terminal 1 (mobile payment terminal) according to an exemplary embodiment of the present disclosure. FIG. 2 is a rear view illustrating a configuration example of portable payment terminal 1. FIG. 3 is a top view illustrating a configuration example of portable payment terminal 1. FIG. 4 is a bottom view illustrating a configuration example of portable payment terminal 1. FIG. 5 is a left side view illustrating a configuration example of portable payment terminal 1. FIG. 6 is a right side view illustrating a configuration example of portable payment terminal 1.

Portable payment terminal 1 is a composite type in which a customer can designate a plurality of payment methods. Portable payment terminal 1 is a mobile terminal that can be held and used by a user including a customer and a store clerk who prompts the customer to make payment.

The plurality of payment methods include at least code payment, contactless payment, contact IC card payment, and magnetic card payment. The code payment is payment by reading a predetermined code, and includes barcode payment, two-dimensional code (for example, QR code (registered trademark)) payment, and the like. The contactless payment is payment made by using contactless communication (for example, near field communication (NFC)), and includes electronic money payment, contactless IC card payment, and the like. The contact IC card payment is payment performed by directly contacting the IC chip of the contact IC card with the contact of the reader/writer, and includes cash card payment, credit card payment, and the like. The magnetic card payment is payment for recording data in a magnetic body of a magnetic card, and includes credit card payment and the like. The plurality of payment methods are performed using each of a plurality of corresponding payment interfaces (described later). Note that portable payment terminal 1 may support other payment methods.

Portable payment terminal 1 has a housing 10 having, for example, a generally box shape. Housing 10 is formed of, for example, resin or the like, and is gripped by the user. Housing 10 has front 11 (FIG. 1) mainly visually recognized by the user and rear 12 (FIG. 2) facing front 11. Further, housing 10 has top 13 (FIG. 3) and bottom 14 (FIG. 4) arranged between front 11 and rear 12. During normal use of portable payment terminal 1, the user places top 13 on the side far from the user himself/herself while looking at front 11, faces bottom 14 toward the user side, and grips the vicinity of bottom 14 with his/her hand to use portable payment terminal 1. Therefore, bottom 14 is a surface on the user side, and top 13 is a surface on the side opposite to the user. Further, housing 10 has two housing sides arranged between front 11 and rear 12, specifically, left housing side 15 (FIG. 5) and right housing side 16 (FIG. 6). Top 13, bottom 14, left housing side 15, and right housing side 16 are substantially perpendicular to front 11 and rear 12.

Note that the coordinate axes in the drawing include, on a plane parallel to front 11, an X-axis that is a direction parallel to top 13 and bottom 14 of the housing, and a Y-axis that is perpendicular to the X-axis and parallel to left housing side 15 and right housing side 16. The coordinate axes further include a Z-axis that is perpendicular to the X-axis and the Y-axis. The X-axis direction corresponds to the width direction of portable payment terminal 1, the Y-axis direction corresponds to the longitudinal direction of portable payment terminal 1, and the Z-axis direction corresponds to the thickness direction of portable payment terminal 1.

As illustrated in FIG. 1, portable payment terminal 1 includes power supply/operation indicating lamp 81 exposed from front 11, illuminance sensor 82 exposed from front 11, touch panel 20 exposed from front 11, and first camera 30 exposed from front 11. As illustrated in FIG. 2, portable payment terminal 1 includes second camera 35 exposed from rear 12, light 83 exposed from rear 12, and aimer 84 exposed from rear 12. Details of touch panel 20, first camera 30, and second camera 35 will be described later.

As illustrated in FIG. 3, portable payment terminal 1 includes contact IC card slot 50 which is arranged on top 13 and into which a contact IC card is inserted. As illustrated in FIGS. 3, 5, and 6, portable payment terminal 1 includes magnetic card slit 60 which is arranged across top 13 and two housing sides (left housing side 15 and right housing side 16) for swiping the magnetic card. As illustrated in FIG. 4, portable payment terminal 1 further includes USB port 85. Details of contact IC card slot 50 and magnetic card slit 60 will be described later.

As illustrated in FIGS. 5 and 6, portable payment terminal 1 includes power supply button 86 and volume button 87 exposed from left housing side 15, side button 88 exposed from right housing side 16, and charging terminals 89.

As described above, portable payment terminal 1 includes touch panel 20. Touch panel 20 has display 25 that is exposed from front 11, can be visually recognized by the user, and can be operated by finger contact, proximity, or the like. Display 25 has a quadrangular shape arranged by top side 21 corresponding to top 13, bottom side 22 corresponding to bottom 14, left side 23 corresponding to one housing side (left housing side 15), and right side 24 corresponding to the other housing side (right housing side 16).

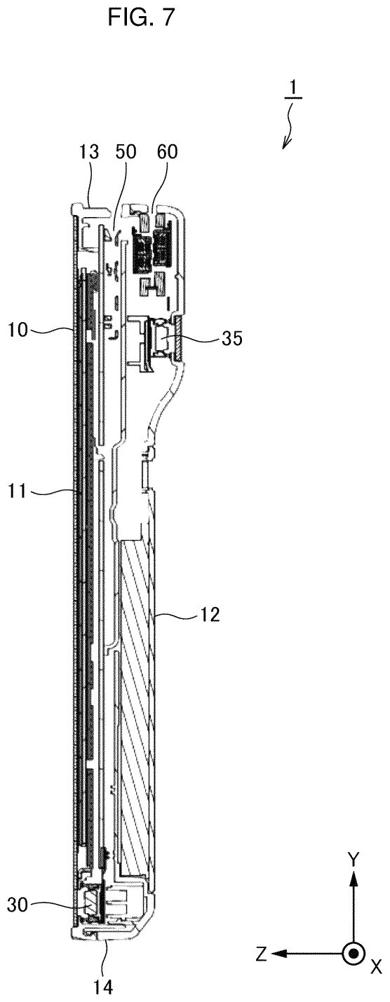

FIG. 7 is a cross-sectional view taken along line I-I in FIG. 1. First camera 30 is arranged closer to bottom 14 in housing 10, the camera lens of first camera 30 is exposed from front 11, and can image a code of code payment arranged to face front 11. The portion having the camera lens is a tall portion of first camera 30. In portable payment terminal 1, a processor (not illustrated) can read the code and recognize the content of the code on the basis of the captured image. For example, when the user grips portable payment terminal 1 with the left hand and holds the code displayed on the screen of his/her own smartphone gripped with the right hand over first camera 30, first camera 30 images the code, and the processor can read the code on the basis of the captured image and perform code payment.

Portable payment terminal 1 further includes second camera 35. Second camera 35 is arranged closer to top 13 in housing 10, and the camera lens of second camera 35 is exposed from rear 12. Second camera 35 is a camera for imaging a commodity code on a commodity from rear 12, separately from the payment described above. In portable payment terminal 1, a processor (not illustrated) can read a commodity code on the basis of a captured image and recognize content related to the commodity code. For example, the user grips portable payment terminal 1 and turns rear 12 to the commodity side, second camera 35 images the code printed on the packing box of the commodity, and the processor can read the commodity code on the basis of the captured image to acquire information of the commodity.

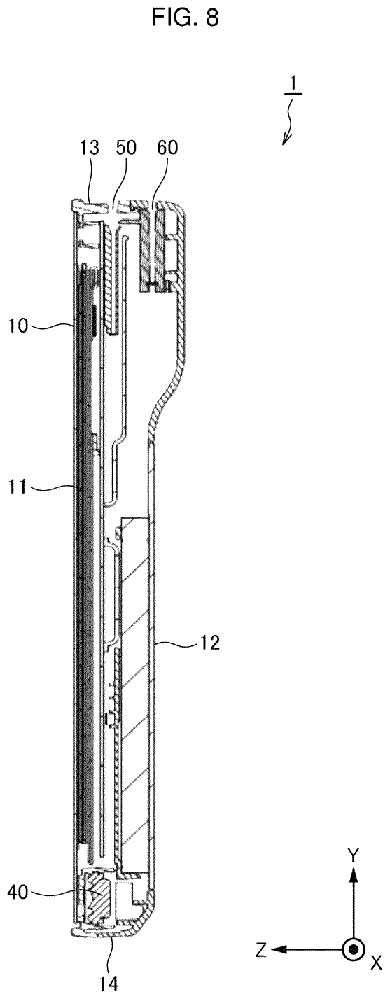

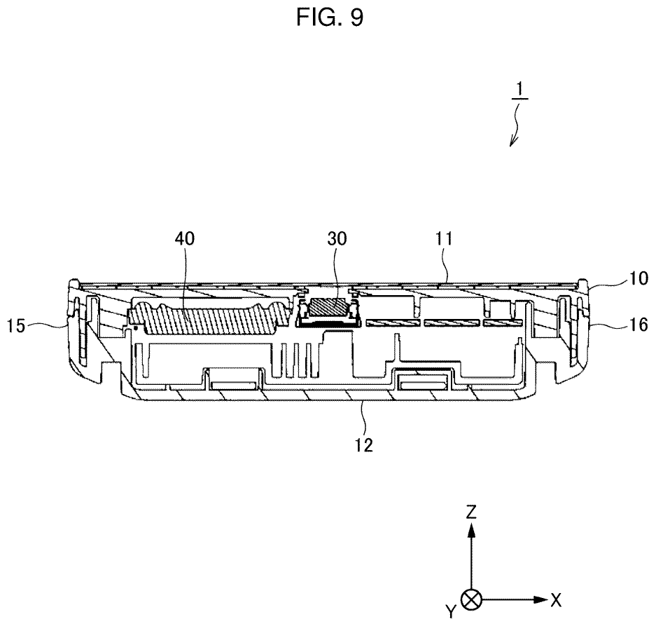

FIG. 8 is a cross-sectional view taken along line II-II of FIG. 1. FIG. 9 is a cross-sectional view taken along line III-III of FIG. 1. Portable payment terminal 1 further includes speaker 40. Speaker 40 is arranged closer to bottom 14 in housing 10 similarly to first camera 30, and the speaker hole is exposed from front 11. Speaker 40 can output a sound of the payment processing from front 11 at the time of payment. A speaker unit that is a portion from which sound is output is a tall portion of speaker 40. The speaker hole is arranged at a position facing the speaker unit.

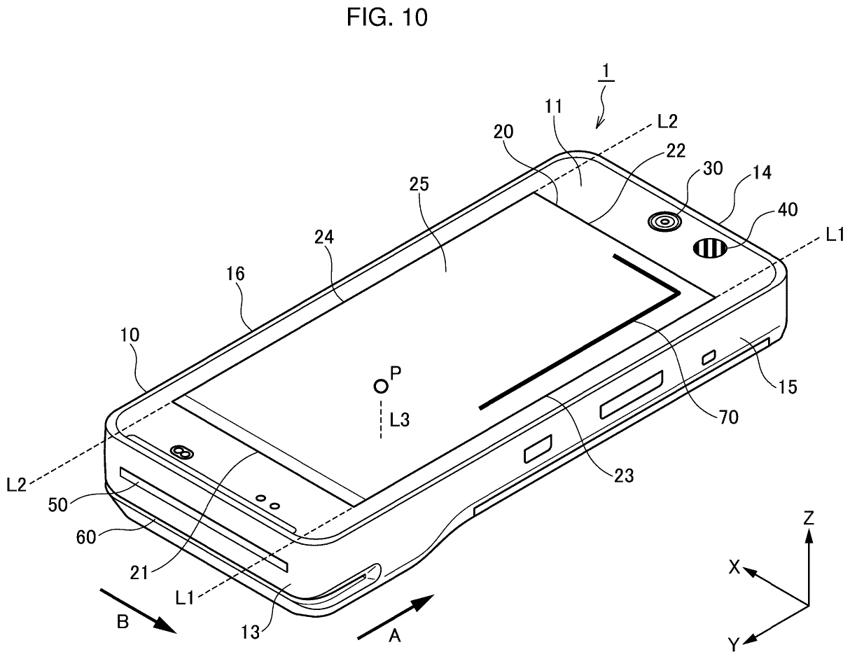

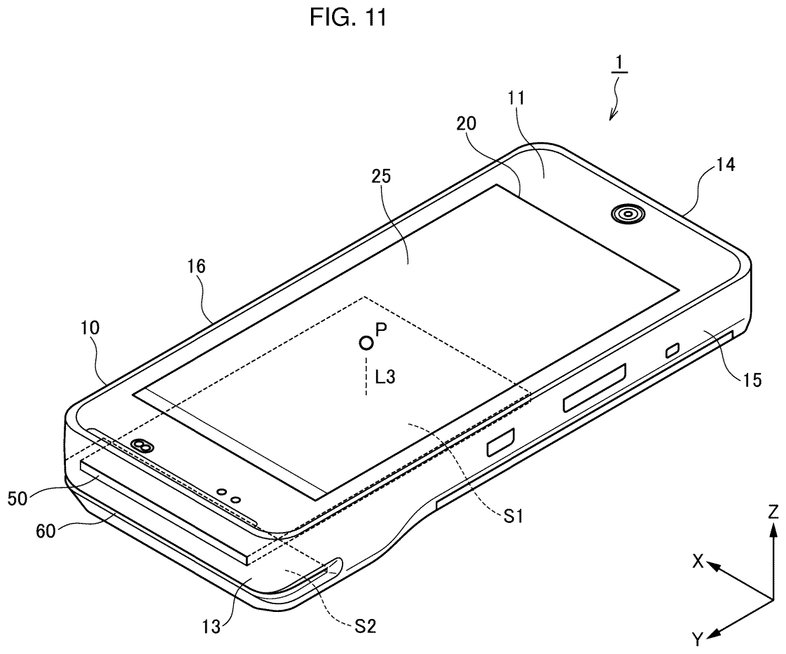

FIG. 10 is a first perspective view illustrating a schematic configuration example of portable payment terminal 1. FIG. 11 is a second perspective view illustrating a schematic configuration example of portable payment terminal 1. FIG. 10 is a diagram mainly illustrating an external configuration of portable payment terminal 1. FIG. 11 is a diagram mainly illustrating an internal configuration of portable payment terminal 1. Note that FIGS. 10 and 11 schematically illustrate portable payment terminal 1 according to the exemplary embodiment, and portable payment terminal 1 according to the exemplary embodiment is different in shape from portable payment terminal 1 illustrated in FIGS. 1 to 9, but is the same terminal as portable payment terminal 1 illustrated in FIGS. 1 to 9.

As illustrated in FIG. 10, first extension line L1 and second extension line L2 which are two extension lines are virtually defined in order to specify portable payment terminal 1 according to the exemplary embodiment. First extension line L1 is a line obtained by extending left side 23 of display 25 of touch panel 20 which is linear. Second extension line L2 is a line obtained by extending right side 24 of display 25 of touch panel 20 which is linear.

The camera lens of first camera 30 is arranged in a region (that is, within the width of display 25) between first extension line L1 and second extension line L2 in housing 10 and closer to bottom 14 of housing 10 with respect to bottom side 22 of display 25. The speaker unit that outputs the sound of speaker 40 is also arranged in a region between first extension line L1 and second extension line L2 in housing 10 and closer to bottom 14 of housing 10 than bottom side 22 of display 25. The speaker hole of the speaker unit is also arranged in a region between first extension line L1 and second extension line L2 and closer to bottom 14 of housing 10 than bottom side 22 of display 25. Therefore, the appearance of the portable payment terminal including the camera lens of the first camera and the speaker hole can be made compact.

Contact IC card slot 50 is arranged in a region between first extension line L1 and second extension line L2 and on top 13 of housing 10. Magnetic card slit 60 is arranged across top 13 and two housing sides (left housing side 15 and right housing side 16) of housing 10.

Furthermore, portable payment terminal 1 includes antenna 70 arranged along at least one of top side 21, bottom side 22, left side 23, and right side 24 of display 25 in housing 10 and used for contactless payment. Antenna 70 of the present exemplary embodiment is an L-shaped antenna arranged along left side 23 and bottom side 22, but may be an I-shaped antenna or an antenna having another shape.

As illustrated in FIG. 11, first space S1 arranged inside contact IC card slot 50 and second space S2 arranged inside magnetic card slit 60 are arranged in housing 10. First space S1, second space S2, and front 11 of housing 10 are arranged substantially parallel to each other.

In addition, first space S1 and second space S2 are arranged closer to top 13 of housing 10 than vertical line L3 extending from center P of display 25 in front view toward rear 12 of housing 10. Contact IC card slot 50 and first space S1 are arranged such that insertion direction A of the contact IC card is substantially parallel to first extension line L1 and second extension line L2. Magnetic card slit 60 and second space S2 are arranged such that swipe direction B of the magnetic card is perpendicular to each of first extension line L1 and second extension line L2.

Components such as first camera 30 and speaker 40 are relatively tall components as compared with other components such as power supply/operation indicator lamp 81, illuminance sensor 82, light 83, aimer 84, or USB port 85, and when arranged in housing 10, portable payment terminal 1 tends to increase in size, particularly in the thickness direction (Z-axis direction). However, in the present exemplary embodiment, components such as first camera 30 and speaker 40 that are relatively tall are arranged closer to bottom 14 of housing 10, and contact IC card slot 50 and magnetic card slit 60 are arranged closer to top 13 of housing 10 where these tall components are not present. Therefore, it is possible to suppress an increase in size, particularly an increase in thickness, of portable payment terminal 1 and to easily achieve a reduction in thickness.

In addition, the camera lens of second camera 35 is arranged in a region between first extension line L1 and second extension line L2 in housing 10 and closer to top 13 of housing 10 than vertical line L3.

Also in second camera 35, a portion having a camera lens is a relatively tall component. As illustrated in FIGS. 5 and 6, the thickness on the side of top 13 of housing 10 on which second camera 35 is arranged is larger than the thickness on the side of bottom 14, but the user does not grip the side of top 13 of housing 10 in normal use. As a result, it is possible to reduce the thickness of bottom 14 side of housing 10 gripped by the user and improve the handleability of portable payment terminal 1 while also mounting second camera 35 capable of reading the commodity code.

As described above, in portable payment terminal 1 of the present exemplary embodiment, components such as first camera 30 and speaker 40 having a relatively tall portion are arranged closer to bottom 14 of housing 10. In addition, contact IC card slot 50 and magnetic card slit 60 are arranged closer to top 13 of housing 10 where a component having such a tall portion does not exist, that is, are arranged in the same direction while being concentrated in one direction. Therefore, the user can easily use contact IC card slot 50 and magnetic card slit 60 while gripping housing 10. In addition, it is possible to easily reduce the thickness of portable payment terminal 1.

In addition, since first camera 30 is arranged closer to bottom 14, it is difficult for the user to block the display on display 25 by hand, and it is easy for the user to hold the code over first camera 30 in a state where the user can easily visually recognize display 25. In addition, since portable payment terminal 1 includes both first camera 30 and second camera 35, it is possible to perform both commodity management and payment.

As described above, at least the following matters are described in the present disclosure. Note that the components and the like corresponding to the above-described exemplary embodiments are shown in parentheses, but the present invention is not limited thereto.

### [Item 1]

A portable payment terminal (portable payment terminal 1), including:
a touch panel (touch panel 20) including a display (display 25), the touch panel being on a front (front 11) of a housing (housing 10);
an antenna (antenna 70) used for contactless payment;
a slot (contact IC card slot 50) into which a contact IC card for payment processing is to be inserted;
a slit (magnetic card slit 60) through which a magnetic card for the payment processing is to be swiped;
a lens of a first camera (first camera 30) that images a code of the payment processing, the lens being arranged on the front; and
a speaker unit (portion that outputs the sound of speaker 40) that is in the housing and outputs a sound of the payment processing,
in which
the slot is arranged on a top (top 13) of the housing and is within a width of the display,
the slit is arranged across the top of the housing and two housing sides (left housing side 15, right housing side 16) adjacent to the top,
the slot and the slit are arranged substantially parallel to the front of the housing,
the slot and the slit are arranged such that an insertion direction of the contact IC card into the slot and a swipe direction of the magnetic card into the slit are arranged substantially perpendicular to each other, and
the lens and the speaker unit are arranged closer to a bottom (bottom 14) of the housing with respect to the display and within the width of the display.

### [Item 2]

The portable payment terminal according to Item 1, in which
the slot includes a first space (first space S1) in the slot,
the slit includes a second space (second space S2) in the slit, and
the first space and the second space are arranged substantially parallel to the front.

### [Item 3]

The portable payment terminal according to Item 1 or 2, in which
the first space and the second space are arranged closer to the top of the housing than a center of the display.

### [Item 4]

The portable payment terminal according to any one of Items 1 to 3, in which
the antenna is arranged along at least one side (top side 21, bottom side 22, left side 23 or right side 24) of the display.

According to each of these items, in the portable payment terminal, components such as the first camera and the speaker having a relatively tall portion are arranged closer to the bottom of the housing, and the slot for the contact IC card and the slit for the magnetic card are arranged closer to the top of the housing where these tall components are not present. In addition, it is possible to easily reduce the thickness of portable payment terminal.

### [Item 5]

The portable payment terminal according to any one of Items 1 to 4, further including a second camera (second camera 35) that images a commodity code related to a commodity,
in which a lens of the second camera is arranged on a rear (rear 12) of the housing and is arranged within the width of the display.

As a result, the portable payment terminal can perform commodity management by also including the second camera, and can also realize thinning of the bottom side of the housing gripped by the user.

Although various exemplary embodiments have been described above with reference to the drawings, it goes without saying that the present disclosure is not limited to such examples. It is obvious that those skilled in the art can conceive various changes or modifications within the scope described in the claims, and it is understood that those changes or modifications naturally belong to the technical scope of the present disclosure. In addition, the components in the above exemplary embodiments may be arbitrarily combined without departing from the gist of the invention.

The present disclosure is useful for a portable payment terminal or the like that can make payment by various payment methods and can achieve miniaturization, particularly thickness reduction.

What is claimed is:

1. A portable payment terminal, comprising:
a touch panel including a display, the touch panel being on a front of a housing;
an antenna used for contactless payment;
a slot into which a contact IC card for payment processing is to be inserted;
a slit through which a magnetic card for the payment processing is to be swiped;
a lens of a first camera that images a code of the payment processing, the lens being arranged on the front; and
a speaker unit that is in the housing and outputs a sound of the payment processing,
wherein
the slot is arranged on a top of the housing and is within a width of the display,
the slit is arranged across the top of the housing and two housing sides adjacent to the top,
the slot and the slit are arranged substantially parallel to the front of the housing,
an insertion direction of the contact IC card into the slot and a swipe direction of the magnetic card into the slit are arranged substantially perpendicular to each other, and
the lens and the speaker unit are arranged closer to a bottom of the housing with respect to the display and within the width of the display.

2. The portable payment terminal according to claim 1, wherein
the slot includes a first space in the slot,
the slit includes a second space in the slit, and
the first space and the second space are arranged substantially parallel to the front.

3. The portable payment terminal according to claim 2, wherein
the first space and the second space are arranged closer to the top of the housing than a center of the display.

4. The portable payment terminal according to claim 3, wherein
the antenna is arranged along at least one side of the display.

5. The portable payment terminal according to claim 4, further comprising a second camera that images a commodity code related to a commodity,
wherein a lens of the second camera is arranged on a rear of the housing and is arranged within the width of the display.

6. The portable payment terminal according to claim 2, wherein
the antenna is arranged along at least one side of the display.

7. The portable payment terminal according to claim 6, further comprising a second camera that images a commodity code related to a commodity,
wherein a lens of the second camera is arranged on a rear of the housing and is arranged within the width of the display.

8. The portable payment terminal according to claim 1, wherein
the slot includes a first space in the slot,
the slit includes a second space in the slit, and
the first space and the second space are arranged closer to the top of the housing than a center of the display.

9. The portable payment terminal according to claim 8, wherein
the antenna is arranged along at least one side of the display.

10. The portable payment terminal according to claim 9, further comprising a second camera that images a commodity code related to a commodity,
wherein a lens of the second camera is arranged on a rear of the housing and is arranged within the width of the display.
